(19) United States
(12) Patent Application Publication
(10) Pub. No.: US 2006/0012638 A1
(43) Pub. Date: Jan. 19, 2006

(54) Ink cartridge with an adhesive insulation layer, method of fabricating the same, and image processing apparatus employing the same

(76) Inventor: Jae-Cheol Lee, Hwaseong-gun (KR)

Correspondence Address: STANZIONE & KIM, LLP, 919 18TH STREET, N.W., SUITE 440, WASHINGTON, DC, 20006, US

(21) Appl. No.: 11/047,578

(22) Filed: Feb. 2, 2005

(30) Foreign Application Priority Data
Jul. 16, 2004 (KR) 2004-55766

(51) Int. Cl. B41J 2/05

(52) U.S. Cl. 347/58

(57) ABSTRACT

An ink cartridge with an adhesive insulation layer and method of fabricating the same are provided. The ink cartridge includes a cartridge main body, a head chip mounted on an upper surface of the cartridge main body, and a flexible printed circuit electrically connected to the head chip and attached to the upper surface of the cartridge main body, wherein the cartridge main body and the flexible printed circuit are adhered to each other by an insulation layer disposed between the cartridge main body and the flexible printed circuit. In addition, the method of fabricating the ink cartridge includes applying sealant on a head chip mounting portion located at the upper surface of a cartridge main body, applying insulation material on a rear surface of an assembly of the head chip and the flexible printed circuit on which a conductive trace is formed, attaching the head chip to the head chip mounting portion, and hot-pressing the flexible printed circuit to attach the flexible printed circuit to the upper surface of the cartridge main body.

### CROSS-REFERENCE TO RELATED APPLICATIONS

This application claims the benefit of Korean Patent Application No. 2004-55766 filed on Jul. 16, 2004, the disclosure of which is hereby incorporated herein by reference in its entirety.

### BACKGROUND OF THE INVENTION

1. Field of the Invention

The present general inventive concept relates to an ink cartridge with an adhesive insulation layer and a method of fabricating the same, and more particularly, to a structure that adheres a flexible printed circuit to an ink cartridge body and also insulates the flexible printed circuit from the ink cartridge body.

2. Description of the Related Art

Recently, various types of image processing apparatuses have been used. In particular, inkjet printers have been widely used due to their low cost and the ease with which they implement color. An inkjet printer prints a desired image on a surface of a recording medium by ejecting ink stored in an ink cartridge in fine ink droplets through an ejection part. Inkjet printers may be classified into two categories based on a mechanism used to generate pressure for ink ejection. A thermal type inkjet head chip ejects the ink droplets using pressure generated by boiling the ink with fine heaters, and a piezo-electric type inkjet head chip ejects the ink droplets using pressure generated by a piezo-electric material.

Referring to FIG. 1, an ink cartridge 10 mounted on an inkjet printer is illustrated. The ink cartridge 10 is provided with a cartridge main body 18 having an ink storing space. A head chip mounting portion 12 is formed on an upper surface (a lower surface in practice) of the cartridge main body 18. The head chip mounting portion 12 has a size larger than that of a head chip 13 to facilitate installation of the head chip 13. A plurality of nozzles 15 for ejecting the ink is formed in the head chip 13, and an ink chamber (not shown) and a heater (not shown) are formed in the head chip 13.

An operation of the head chip 13 is controlled by a controller (not shown) mounted on a printer main body, and the controller is connected to the head chip 13 by a flexible printed circuit (FPC) 20. That is, a plurality of electrodes 22 for contacting the controller are formed on one side of the FPC 20, which are connected to the heater in the head chip 13 through a conductive trace 24. FIG. 1 illustrates the conductive trace 24 for clarity, but in practice the conductive trace 24 typically has a plate shape, at which a plurality of wires are disposed in alignment. A part of the conductive trace 24 is exposed to an exterior through a part of the head chip mounting portion 12, of which the exposed part is protected by a bead 11. In addition, as illustrated in FIG. 2, a side sealant 16 is applied between sides of the head chip 13 and inner walls of the head chip mounting portion 12 to prevent the ink from leaking and to stably fix the head chip 13.

Referring to FIGS. 1 to 4, the flexible printed circuit (FPC) 20 is attached to the cartridge main body 18 in an assembly form attached to the head chip 13. The FPC 20 is divided into a front surface region 20a, an upper surface region 20b, and a rear surface region 20c depending upon positions of surfaces attached to the cartridge main body 18. The FPC 20 has a structure as shown in FIG. 2 after completing the attachment. That is, an upper adhesion layer 40b made of thermosetting resin is disposed on an upper surface of the cartridge main body 18, an insulation layer 30 is disposed on the adhesion layer 40b, and the conductive trace 24 and the FPC 20 are sequentially disposed on the insulation layer 30. The adhesion layer may also be divided into a front surface adhesion layer 40a, the upper surface adhesion layer 40b, and a rear surface adhesion layer 40c.

A conventional adhesion layer typically uses a pressure sensitive adhesive (PSA) or a thermal bonded film (TBF). The insulation layer 30, as illustrated in FIG. 4, is attached to a rear surface of the FPC 20 by a photo solder resist method or a film laminating method. The adhesion layer 40, made of the thermosetting resin, is then attached and pressed or hot-pressed to a rear surface of the flexible printed circuit or the upper surface of the cartridge main body 18, thereby completing the attachment.

However, the adhesion layer 40, made of the thermosetting resin, has a low ink-proof. In particular, using a strong alkaline ink having a pH of more than 11 may deteriorate the two types of adhesives (i.e., pressure sensitive adhesive and thermal bonded film). As a result, their adhesion properties are lowered due to unevenness of an adhesion surface caused by ink swelling. In addition, when the adhesion layer 40 is deteriorated, the ink is introduced through the deteriorated adhesion layer to cause a short circuit between parts of the conductive trace 24.

In manufacturing processes, the adhesion layer 40 is generally supplied from a wound reel, and the adhesion layer 40 is lengthened due to its high coefficient of tension, thus making it difficult to attach the adhesion layer 40 in place. Furthermore, even when the adhesion layer 40 is attached, a process of curing the side sealant 16 is progressed at a temperature of about 110° C. for at least one hour, in which heat from the process may cause a decrease in a strength of the adhesion layer 40 or may cause an adhered portion to separate.

### SUMMARY OF THE INVENTION

The present general inventive concept provides an ink cartridge capable of improving an adhesive strength and stabilizing an adhered surface by making the adhered surface alkaline ink-proof, and maintaining stability of the ink cartridge regardless of a high temperature used to cure a side sealant.

The present general inventive concept provides a method of fabricating an ink cartridge and forming an adhesion layer and an insulation layer by a single process such that the adhesion layer on a flexible printed circuit may be formed when the flexible printed circuit is set in place.

The present general inventive concept provides an image processing apparatus having the ink cartridge.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an ink cartridge including a cartridge main body, a head chip mounted on an upper surface of the cartridge main body, and a flexible printed circuit electrically connected to the head chip and attached to the upper surface of the cartridge main body, wherein the cartridge main body and the flexible printed circuit are adhered to each other by an insulation layer disposed therebetween.

The insulation layer of the present general inventive concept has adhesive properties and functions both as an insulation layer and an adhesion layer. Since a single layer according to the present general inventive concept serves both insulating and adhering purposes, the insulation layer and the adhesion layer need not be separately formed while attaching the ink cartridge main body to an assembly of the head-chip and the flexible printed circuit as previously done in conventional methods. The insulation layer may be made of an epoxy-based material. A liquefied epoxy-based material may be applied on a rear surface of the flexible printed circuit (FPC) to form the insulation layer, and then the insulation layer may be placed on the cartridge main body and hot-pressed thereto. As a result, the FPC may be attached to the cartridge main body by virtue of adhesive properties of the epoxy-based material. The insulation layer of the epoxy-based material may be formed by a screen printing method or a photo solder resist method. Since the adhesion layer is formed by a single process, the ink cartridge may be easily manufactured and the adhesion layer may be formed when the flexible printed circuit is set in place.

The epoxy-based material may contain an epoxy resin. If the epoxy-based material contains close to 100% epoxy resin, it may be difficult to initially position the epoxy resin at the cartridge main body, since initial adhesive properties of epoxy resin prior to curing may typically be low. Therefore, when the epoxy-based material contains an epoxy resin of about 80˜90% by weight and a remainder having thermosetting resin and other additives, the initial adhesive properties may be improved so that the epoxy-based material may be easily positioned on the cartridge main body. In this process, the thermosetting resin may be any material selected from a group including polypropylene (PP), polystyrene (PS) and polyethyleneterephthalate (PET), or a mixture thereof.

The insulation layer may have a thickness of about 20˜100 micrometers (μm). However, if the insulation layer has a thickness less than 20 μm, the insulation layer may provide insufficient insulation. Additionally, if the thickness of the insulation layer is less than 20 μm, the insulation layer may also provide insufficient adhesion since the insulation layer may not be thick enough to conform to unevenness in the upper surface of the cartridge main body. If the thickness of the insulation is more than 100 μm, forming a flat insulation layer becomes difficult.

The foregoing and/or other aspects and advantages of the present general inventive concept may also be achieved by providing a method of fabricating an ink cartridge including applying sealant on a head chip mounting portion located at an upper surface of a cartridge main body, applying an insulation material to a rear surface of an assembly of a head chip and a flexible printed circuit on which a conductive trace is formed, attaching the head chip to the head chip mounting portion, and hot-pressing the flexible printed circuit to attach the flexible printed circuit to the upper surface of the cartridge main body.

As described above, the insulation material may be an epoxy-based material containing an epoxy resin of about 80˜90% by weight and a remainder having a thermosetting resin and other additives. In addition, the insulation material may be applied on the rear surface of the assembly of the head chip and the flexible printed circuit, or on the cartridge main body itself.

Hot-pressing the flexible printed circuit (FPC) may be performed at a temperature of about 100˜160° C. for about 3˜60 seconds. If a temperature less than 100° C. is used, curing may not be performed as smoothly. If a temperature of more than 160° C. is used, the cartridge main body, which is formed of plastic resin, may be deformed. In addition, if a cure time of less than 3 seconds is used, the curing may be not sufficiently performed; and if a cure time of more than 60 seconds is used, the cartridge main body may be deformed.

A plurality of ink cartridges may be pressed with an flexible printed circuit (FPC) in a batch. Hot-pressing an FPC to each of a plurality of ink cartridges may include a first curing process performed at a temperature of about 100˜160° C. for about 3˜60 seconds during which each of the plurality of ink cartridges is set in place by a fixing jig; and second curing process performed in the same conditions as the first curing process by putting a plurality of partially-cured ink cartridges into a chamber after the first curing process. In other words, hot-pressing the FPC may use a fixing jig to fix the FPC in place on the cartridge main body, however the number of ink cartridges cured using the fixing jig at the same time may be limited. The curing process that uses the fixing jig may perform about 80˜90% of the entire curing process to achieve some extent of adhesion. Once some adhesion is achieved, the plurality of partially-cured ink cartridges are put into the chamber at the same time to perform the rest of the curing, thereby completing a process of hot-pressing FPCs on the plurality of ink cartridges.

The foregoing and/or other aspects and advantages of the present general inventive concept may also be achieved by providing an image processing apparatus including the above-mentioned ink cartridge or an ink cartridge fabricated by the method described above.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a conventional ink cartridge;

FIG. 2 is a cross-sectional view taken along the line I-I in FIG. 1;

FIG. 3 is a plan view illustrating an assembly of a head chip and a flexible printed circuit of the conventional ink cartridge of FIG. 1;

FIG. 4 is a plan view illustrating an insulation layer and an adhesion layer of the conventional ink cartridge of FIG. 1;

FIG. 5 is a cross-sectional view illustrating an ink cartridge according to an embodiment of the present general inventive concept;

FIG. 6 is a plan view illustrating a flexible printed circuit and an insulation layer mounted on the ink cartridge of FIG. 5;

FIG. 7 is a flow chart illustrating a method of fabricating an ink cartridge according to an embodiment of the present general inventive concept; and

FIG. 8 is a flow chart illustrating a method of fabricating an ink cartridge according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, embodiments of an ink cartridge and a method of fabricating the same in accordance with the present general inventive concept will be described with reference to the accompanying drawings.

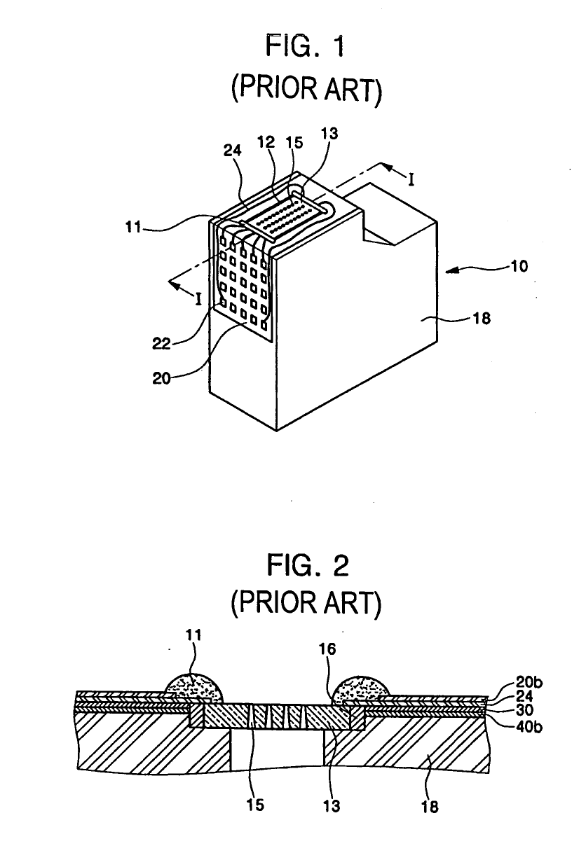

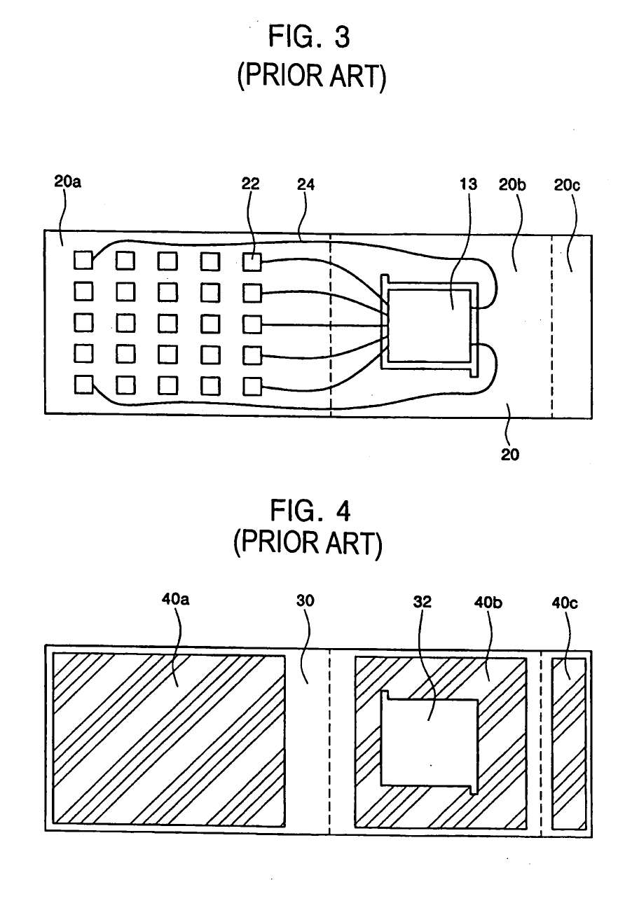

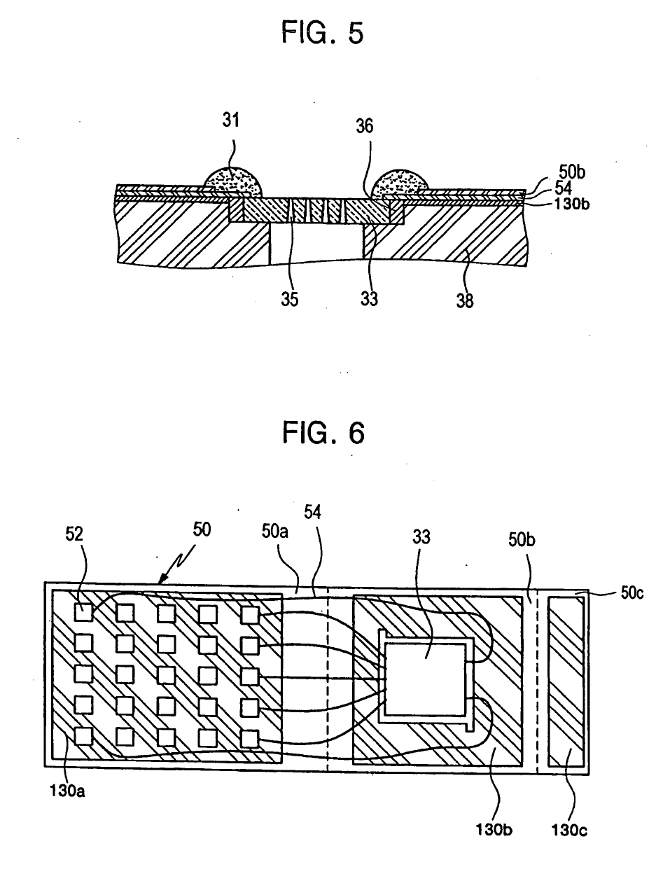

Referring to FIGS. 5 and 6, a head chip 33 (similar to 13 in FIGS. 1 to 3) having a plurality of nozzles is mounted on a head chip mounting portion (similar to 12 in FIG. 1) of a cartridge main body 38 (similar to 18 in FIGS. 1 and 2), and a side sealant 36 (similar to 16 in FIG. 2) is filled in a space between the head chip 33 and the head chip mounting portion to prevent ink from leaking between the head chip 33 and the cartridge main body 38. An upper insulation layer 130b made of an epoxy resin-based material is disposed on a remaining portion of an upper surface of the cartridge main body 38 with the exception of the head chip mounting portion. It should be understood that the upper surface of the cartridge main body 38 having the head chip 33 thereon is typically positioned face down above a recording medium when the ink cartridge is disposed in a printer. The description of the different surfaces of the ink cartridge main body 38 in relation to one another are not meant to be limiting, and are used merely for illustration purposes. The upper insulation layer 130b, a front insulation layer 130a, and a rear insulation layer 130c, respectively, are made of the epoxy resin-based material. The front insulation layer 130a is located at a front surface of the cartridge main body 38, the upper insulation layer 130b is located at the upper surface of the cartridge main body 38, and the rear insulation layer 130c is located at a rear surface of the cartridge main body 38. The front, upper, and rear surfaces of the cartridge main body 38 are similar to those of the cartridge main body 18 illustrated in FIG. 1. Since the upper insulation layer 130b mostly contains an epoxy resin, adhesive properties of the upper insulation layer 130b are strengthened by hot-pressing the cartridge main body 38 to a conductive trace 54 (similar to 24 in FIGS. 1 to 3) and the flexible printed circuit 50b so that the conductive trace 54 and the flexible printed circuit 50b are adhered to the cartridge main body 38.

A bead 31 is formed at ends of the head chip 33, where the head chip meets the conductive trace 54 and the flexible printed circuit (FPC) 50b to prevent the ink from being introduced to the conductive trace 54 or the FPC 50b and/or disadhering the conductive trace 54 or the FPC 50b.

Referring to FIG. 6, the insulation layer is divided into the three insulation layer parts 130a, 130b and 130c to be applied by a screen printing method or a photo solder resist method on a rear surface of the FPC 50b, and then attached to the cartridge main body 18. The FPC 50 may also be divided into three parts and a remaining part, at which the insulation layer 130 is not applied, and therefore has no adhesion. Thus, the remaining part may be a point of reference when it is attached to the cartridge main body 38. That is, the remaining part of the FPC 50 is first placed in contact with a corner of the cartridge main body 38 so that a position of the FPC 50 with respect to the cartridge main body 38 may be adjusted. This may facilitate attachment of the insulation layer (130a, 130b, and 130c). Alternatively, it may be possible to apply an insulation layer on an entire rear surface of the FPC 50 so that there is no remaining part. In this case, the insulation layer may be uniformly applied on the entire rear surface of the FPC 50, thereby adhering the entire FPC 50 to the cartridge main body 38.

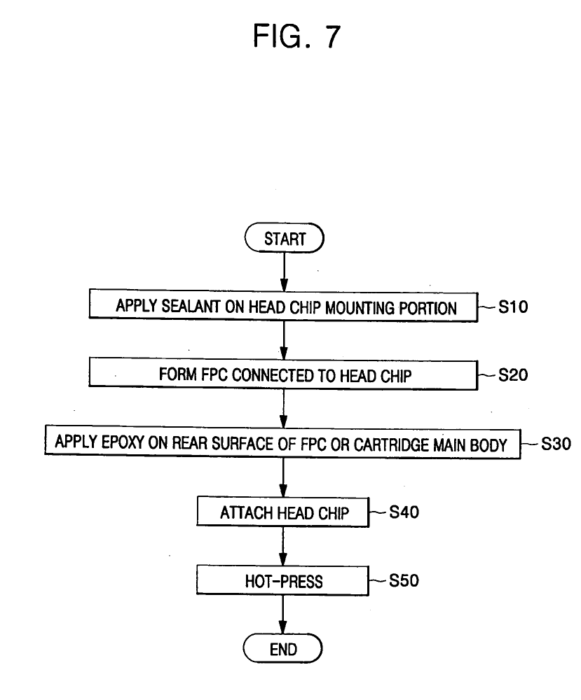

Referring to FIG. 7, a method of fabricating an ink cartridge according to an embodiment of the present general inventive concept is illustrated.

In S10, a sealant to fix a head chip on a head chip mounting portion is applied to a cartridge main body, at which the head chip mounting portion is formed. In S20, a terminal formed in the head chip is connected to a flexible printed circuit (FPC) to form an FPC assembly. A liquefied epoxy resin-based material is applied on a rear surface of the FPC assembly (S30). The epoxy resin-based material may be a one liquid type or a two liquid type.

Once the head chip is attached at the head chip mounting portion (S40), the FPC is aligned in place to hot-press and cure (S50), thereby completing adhesion of the FPC assembly to the cartridge main body. In S40, hot-pressing is performed at a temperature of about 100˜160° C. for about 3˜60 seconds until the FPC assembly is completely cured during which the FPC is set in place using a fixing jig. When curing is completed, a sealant is applied and cured in a space between the head chip and the head chip mounting portion, thereby forming a bead and completing the fabrication of the ink cartridge.

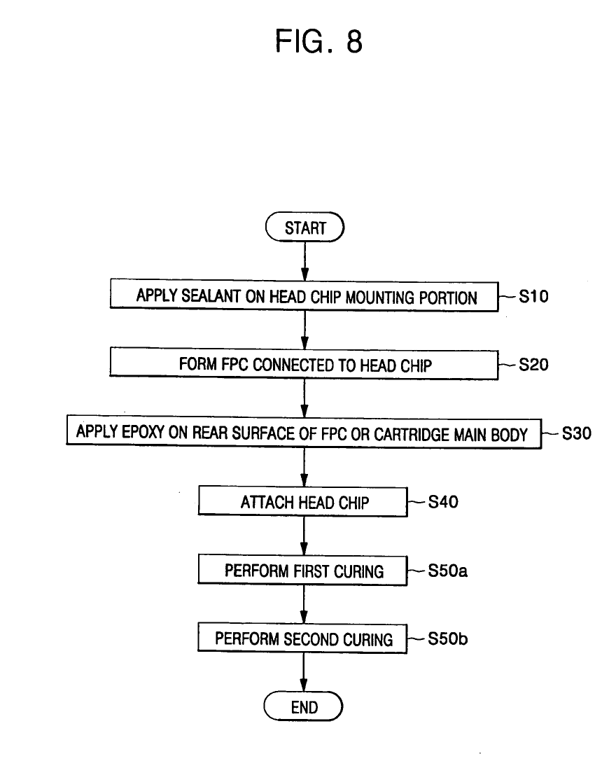

Referring to FIG. 8, a method of fabricating an ink cartridge according to another embodiment of the present general inventive concept is illustrated. Operations S10 to S40 in the present embodiment illustrated in FIG. 8 are similar to corresponding operations illustrated in the embodiment of FIG. 7, and therefore their descriptions will be omitted.

Once the head chip is attached at the head chip mounting portion of the cartridge main body, each of a plurality of ink cartridges are mounted on the fixing jig to secure an FPC thereto, and then a first curing operation S50a is performed at a temperature of about 100˜160° C. for about 3˜60 seconds until the FPC is cured to about 80˜90%. Then, a plurality of partially-cured ink cartridges, for which the first curing operation S50a is complete, are separated from the fixing jig and put in a chamber for a second curing operation. A second curing operation S50b is then performed at the same temperature and for the same amount of time as in the first curing operation S50a, thereby completing the curing process.

While the embodiment illustrated in FIG. 8 that performs two curing operations has a larger number of processes in comparison with the embodiment illustrated in FIG. 7, since the plurality of ink cartridges may be processed in the second curing operation S50b at the same time, the embodiment illustrated in FIG. 8 may have an advantage of being used in mass production. Thus, the embodiment illustrated in FIG. 8 may enable a plurality of ink cartridges to be manufactured at the same time.

As can be seen from the foregoing, the present general inventive concept is capable of improving productivity by simplifying the process of fabricating an ink cartridge. Since the insulation layer has adhesive properties, the insulation layer may be used to insulate and adhere the FPC and the cartridge main body. In particular, conventional ink cartridges have had problems caused by high elongation of an adhesion film while attaching the adhesion film to the FPC. This problem may be alleviated by the present general inventive concept.

In addition, the insulation layer made of an epoxy resin-based material has a high resistance to strong alkaline ink to prevent the insulation layer from becoming uneven due to deterioration and to prevent an electrical short circuit due to swelling caused by reaction with the ink. This ensures reliability of the ink cartridge. In particular, since the epoxy resin-based material is stabilized after the reaction caused by the curing process, the epoxy resin-based material does not lose adhesive strength and become deformed, even when the epoxy resin-based material is exposed to a harsh environment of the sealant curing process (generally 110° C., for one hour) used to cure a bead.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge comprising:
a cartridge main body;
a head chip mounted on an upper surface of the cartridge main body; and
a flexible printed circuit electrically connected to the head chip and attached to the upper surface of the cartridge main body;
wherein the cartridge main body and the flexible printed circuit are adhered to each other by an insulation layer disposed between the cartridge main body and the flexible printed circuit.

2. The ink cartridge according to claim 1, wherein the insulation layer is made of an epoxy-based material, and the insulation layer is hot-pressed to attach the flexible printed circuit.

3. The ink cartridge according to claim 2, wherein the epoxy based material is alkaline ink-proof.

4. The ink cartridge according to claim 2, wherein the epoxy-based material contains an epoxy resin of about 80˜90% by weight, and a remainder having the thermosetting resin and additives.

5. The ink cartridge according to claim 4, wherein the thermosetting resin includes any material selected from a group consisting of: polypropylene (PP), polystyrene (PS) and polyethyleneterephthalate (PET), or a mixture thereof.

6. The ink cartridge according to claim 1, wherein the insulation layer has a thickness of about 20˜100 μm.

7. An ink cartridge comprising:
a cartridge main body;
a flexible printed circuit assembly disposed on a surface of the cartridge main body and having an inkjet head chip; and
a single layer of material disposed between the surface of the cartridge main body and the flexible printed circuit assembly to insulate the flexible printed circuit assembly from the cartridge main body and to adhere the flexible printed circuit assembly to the cartridge main body.

8. The ink cartridge according to claim 7, wherein the inkjet head chip is attached to the surface of the cartridge main body at an inkjet head mounting portion located at an upper surface of the cartridge main body.

9. The ink cartridge according to claim 7, wherein the single layer of material comprises an epoxy based material.

10. The ink cartridge according to claim 9, wherein the epoxy based material contains 80-90% epoxy resin by weight and a remainder comprising of one or more of polypropelene, polystyrene, and polyethyleneterephthalate.

11. The ink cartridge according to claim 7, wherein the single layer of material has a thickness between 20 micrometers and 100 micrometers.

12. A method of fabricating an ink cartridge, the method comprising:
applying sealant on a head chip mounting portion located at an upper surface of a cartridge main body;
applying an insulation material on a rear surface of an assembly of a head chip and a flexible printed circuit, at which a conductive trace is formed;
attaching the head chip of the assembly on the head chip mounting portion; and
hot-pressing the flexible printed circuit of the assembly attached to the upper surface of the cartridge main body.

13. The method according to claim 12, wherein the insulation material is an epoxy resin-based material.

14. The method according to claim 13, wherein the insulation material contains an epoxy resin of about 80˜90% by weight, and a remainder having thermosetting resin and additives.

15. The method according to claim 12, wherein hot-pressing the flexible printed circuit is performed at a temperature of about 100˜160° C. for about 3˜60 seconds.

16. The method according to claim 12, wherein hot-pressing the flexible printed circuit comprises:
performing a first curing at a temperature of about 100˜160° C. during about 3˜60 seconds while each of the cartridges is set in place with a fixing jig; and
performing a second curing in the same conditions as the first curing by putting a plurality of partially-cured cartridges into a chamber after the first curing.

17. A method of fabricating an ink cartridge, the method comprising:
applying an insulation material to one of a rear surface of a flexible printed circuit assembly and a surface of a main body portion of the ink cartridge;
adhering the rear surface of the flexible printed circuit assembly to the surface of the main body portion of the ink cartridge using the insulation material.

18. The method according to claim 17, wherein the flexible printed circuit assembly comprises an inkjet head chip and a plurality of electrodes electrically connected to the inkjet head chip by a plurality of conductive traces.

19. The method according to claim 17, wherein the flexible printed circuit assembly is divided into an upper surface including an inkjet head chip, a front surface including a plurality of electrodes, a rear surface, and a remaining part,
wherein the applying of the insulation material to one of the rear surface of the flexible printed circuit assembly and the surface of the main body portion of the ink cartridge further comprises applying the insulation material to the upper, front, and rear surfaces of the flexible printed circuit assembly, and
wherein the adhering of the rear surface of the flexible printed circuit assembly to the surface of the main body portion of the ink cartridge further comprises setting the remaining part as a reference point at a corner of the main body portion of the ink cartridge and setting the upper, front, and rear surfaces of the flexible printed circuit assembly on upper, front, and rear surfaces of the main body portion of the ink cartridge, respectively.

20. The method according to claim 17, wherein the applying of the insulation material to one of the rear surface of the flexible printed circuit assembly and the surface of the main body portion of the ink cartridge further comprises applying an epoxy based material to the rear surface of the flexible printed circuit assembly.

21. The method according to claim 20, wherein the applying of the epoxy based material further comprises applying a material containing 80-90% epoxy resin by weight and a remainder comprising of one or more of polypropelene, polystyrene, and polyethyleneterephthalate.

22. The method according to claim 17, wherein the adhering of the rear surface of the flexible printed circuit assembly to the surface of the main body portion of the ink cartridge using the insulation material comprises:
setting the flexible printed circuit assembly in a predetermined position with respect to the main body portion of the ink cartridge; and
hot-pressing the insulation material to create adhesion between the flexible printed circuit assembly and the main body portion of the ink cartridge.

23. The method according to claim 22, wherein the hot-pressing the insulation material comprises curing the insulation material at a temperature between 100-160 degrees Celsius for 3-60 seconds.

24. A method of fabricating ink cartridges, the method comprising:
providing a plurality of cartridge main bodies;
providing a plurality of flexible printed circuit assemblies having inkjet head chips and electrodes;
applying an insulation material to one of a rear surface of each of the plurality flexible printed circuit assemblies and a surface of each of the plurality of cartridge main bodies; and
adhering the rear surfaces of the plurality of flexible printed circuit assemblies to the surface of the plurality of cartridge main bodies using the insulation material, the adhering operation comprising:
setting at least one of the plurality of flexible printed circuit assemblies in a predetermined position with respect to a corresponding one of the plurality of cartridge main bodies using a fixing jig and performing a first cure to partially cure the at least one of the plurality of flexible printed circuit assemblies to the corresponding one of the plurality of cartridge main bodies, and
performing a second cure to cure a plurality of partially-cured cartridge main bodies.

25. The method according to claim 24, wherein the first cure is performed while the at least one of the plurality of flexible printed circuit assemblies is set in the predetermined position with respect to the corresponding one of the plurality of cartridge main bodies by the fixing jig.

26. The method according to claim 24, wherein the first cure partially cures the at least one of the plurality of flexible printed circuit assemblies to the corresponding one of the plurality of cartridge main bodies about 80-90% to completion.

27. The method according to claim 24, wherein performing a second cure to cure the plurality of partially-cured cartridge main bodies further comprises putting the plurality of partially-cured ink cartridge main bodies in a chamber and second curing the plurality of partially-cured cartridge main bodies to completion at the same time.
